(19) United States
(12) Patent Application Publication
(10) Pub. No.: US 2003/0031347 A1
(43) Pub. Date: Feb. 13, 2003

(54) Biosecure method and device

(76) Inventor: Wei-Kung Wang, Taipei (TW)

Correspondence Address: Ladas & Parry, 26 West 61st Street, New York, NY, 10023, US

(21) Appl. No.: 10/207,610

(22) Filed: Jul. 29, 2002

(30) Foreign Application Priority Data
Aug. 2, 2001 (TW) 090119107

(51) Int. Cl. G06K 9/00

(52) U.S. Cl. 382/115

(57) ABSTRACT

Disclosed is a biosecure method and device for identifying a person. According to one embodiment of the present invention, said device comprises: a light source for directing a light beam to a part of the person's body; a detector for measuring the light from the part of the person's body and converting the light intensity into electrical signals of a spectrum; and a spectrum analyzer and comparator for analyzing the spectrum and comparing the spectrum with stored spectrum for the person. The present invention provides a biosecure system, which is simple, cost-effective and hard to be faked.

### BACKGROUND AND SUMMARY OF INVENTION

Because personal electronic devices, especially portable devices like cellular phones, palms and notebook computers, are easily to be lost or stolen by others, there is a need for a security system in order to identify the right owner. In addition, in web-business or e-business transactions, there is a need to identify the really authorized person. Simply a username and code may serve for this purpose; however, the username and code is very easily and likely to be known by others, so that the electronic devices could be used without consent from the owner, and the transaction or authorized area may be accessed illegally. Therefore, how to identify a person without seeing that person face-to-face is a very challenging issue.

Recently, there have been some concepts developed about how to use each person's biological figure, such as finger print, lines on palms, or even face figure or vein profile on the back of hand, for the identification of a person.

The present invention discloses a novel biosecure system, which is simple, cost-effective and hard to be faked. The present invention uses the biological figure of a person for identity, by way of analyzing the spectrum (transmission or scattering) of the light of that person, especially using the spectrum of that person as a function of time for identity.

### BRIEF DESCRIPTION OF DRAWING

The present invention can be better understood through the accompanying drawing in which:

FIG. 1 shows a biosecure system, according to one embodiment of the present invention.

### DETAILED DESCRIPTION OF INVENTION

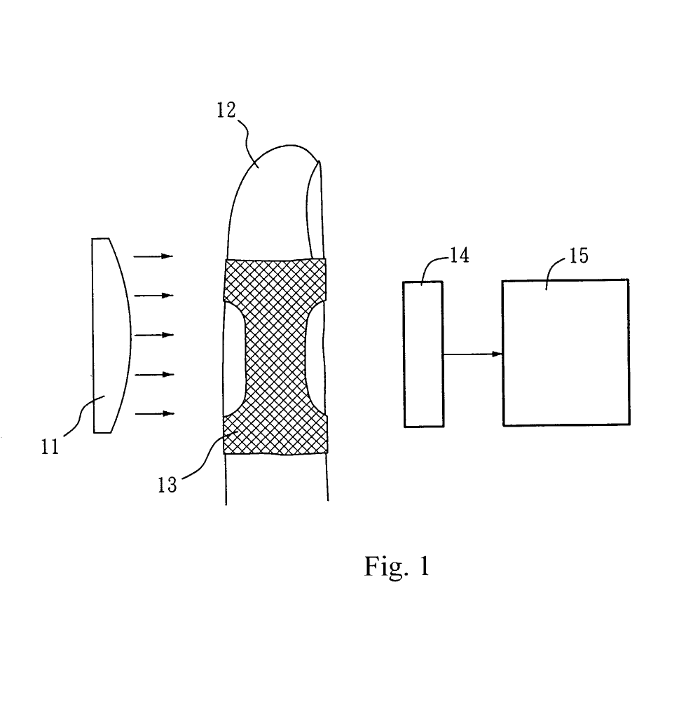

Referring to FIG. 1, the light from light source 11 is transmitted through the finger 12, then through the transparent part (the white part on the envelope 13) of the envelope 13, and then enters a detector 14 to be converted into electrical signal to be analyzed by a spectrum analyzer 15. The analysis result can be compared by a comparator 15 to the identity data stored in advance for a specific person, to identify the person.

When a light 11 is incident upon a tissue (e.g., a finger 12) of a person, a spectrum unique for each different person will be generated. Such a spectrum can be utilized to identify a person. The spectrum varies with the amount of blood in the artery in the tissue and thus, it will vary with the heartbeat. Since the ratio of transmittance for each wavelength at minimum to maximum is different for each different person, therefore such information can also be used as an intrinsic code for a specific person.

A human being has ten fingers, each of which has its unique spectrum, maximum and minimum values with respect to time. Thus, different information for different fingers can be used as additional codes for identity.

The spectrum is generated by a light source 11 with a specific wavelength. A different light source could result in different spectrum and thus the property of the light source 11 can be used as a code, too.

In another embodiment of the present invention, a code can be assigned to each finger, for example, right hand thumb as number 1, right hand index as 2, middle as 3 . . . , and left hand thumb as number 6, left hand index as 7, and so forth. According to such assignment, codes 3, 2, 7 stand for the spectral information of right middle, right index and left index fingers, respectively.

Therefore, a code sequence with each finger spectrum as the base can be arranged, and this code sequence can hardly be copied or broken by others. The code sequence is an intrinsic signal of biological identity that exists only in the specific person as long as that person is alive.

It should be noted that human tissue is an inhomogeneous structure. An envelope 13 can be used to shape the light beam to penetrate via a particular path and thus, the spectrum can be generated in a specific fashion. Likewise, the envelope 13 can be designed as an additional code.

One of the advantages of the biosecure system of the present invention is that the system can be used in combination with different kinds of codes. Some of the examples include:

(1) Four envelopes of different configurations are designed and designated as four codes A, B, C and D.

(2) Each finger is designated with a code from 1 to 10, respectively.

(3) Three wavelengths of different light sources are selected as three codes of α, β, and γ (e.g., 910 nm, 1065 nm and 1310 nm).

As a result, a code in three digits and in whatever length can be obtained as follows:

For N codes (N is an integer):

| 1 | 2 | 3 | | | | | N |
|---|---|---|---|---|---|---|---|
| A1α | B2α | . . . | A3γ | . . . | C8α | . . . | B3β |

Each specific code carries a specific kind of biological information, which is from the blood circulation as well as tissue spectrum, of a specific person. The secure system works as a specific filter (or mask) that contains a special code, which will not be faked by other persons. The code can be carried with that specific person who does not need to memorize it.

The biosecure system according to the present invention is highly safe. The system can be built up together with the electronic devices like a cellular phone, palm or notebook computer, as a part of their ID or authorization process. One code as simple as, for example, A1α or C8α, can be used to accurately identify the owner of the device. For the purpose of web-use, the code can be used as authorized code that can hardly be duplicated.

For example, a personal electronic such as a computer is designed to have a code A3γ as the password to open it, which in terms of the above-mentioned code definition, requires an envelope (A) with a hole tailored to the computer owner's left middle finger (3), as well as a built-in light source having a wavelength of 1310 nm (γ).

The spectrum could also be changed along with the heartbeat. In order to analyze the change, the frequency analysis could be used, which includes constant part (defined as DC part) and certain time varying part changing according to time (defined as AC part). The frequency analysis method is suitable for analyzing the frequency content of the time varying intensity of the AC part. Since the AC signal is related to heartbeat and will repeat itself, the harmonic analysis is a useful way to analyze its composition.

It should be highlighted that a biological system for a person is not a fixed system, and it can change with the age of the person. To adapt such natural process of the biological system, an adaptive system can be set up. The built-in biological code, such as maximum/minimum ratio, frequency of maximum and minimum etc, allows a variation (for example, 5%) for each successful usage. The biological code, shifts its value to a newly measured value which could be, for example, 1% away from the original value, and then the new value can be used as the center. In this way, the system can be adapted to the natural aging process, and the ability to identify the same person can be maintained even if the person's age is always changing with respect to time.

For the light source 11, an LED (light emitting diode), LD (laser diode) or lamp can be used. To analyze the spectrum, the spectrum analyzer 15 could be implemented by a band pass filter, prism or grating, etc. The detector 14 could be a photo detector such as a Si, GaAs or InGaAs detector. For example, InGaAs detector can be used to detect the light of a 1310 nm wavelength (from the light source such as LED, LD or lamp).

The biosecure device can be established in a phone (including a cellular phone), computer and other personal devices. It can be used for safety and security for building a lock. In general, all locks can be designed according to the above-mentioned method and the key to the locks is just the right person's finger. In web-trade or e-business, the ID may be designed in this way and then “open sesame” can be personalized so that the door is open only for the right person. All other kinds of codes can also be designed in the same manner. As an example of the web ID, the spectrum signal is transmitted with all the available security method, and the DC intensity and AC frequency composition can be decoded as the ID.

As the invention thus described, it will be obvious that the embodiments and description are not intended to limit the invention. The invention may vary in many ways. Such variations are not to be regarded as a departure from the spirit and scope of the invention, and all such modifications, as would be obvious to one skilled in the art, are intended for inclusion within the scope of the following claims.

We Claim:

1. A biosecure method for identifying a person, comprising:
directing a light beam to a part of the person's body;
analyzing a light spectrum generated therefrom; and
comparing analysis result of the spectrum with stored data for the person.

2. The biosecure method according to claim 1, wherein said spectrum comprises transmitted light spectrum.

3. The biosecure method according to claim 1, wherein said spectrum comprises scattered light spectrum.

4. The biosecure method according to claim 1, wherein said spectrum comprises changes with respect to time.

5. The biosecure method according to claim 1, wherein said spectrum comprises infrared spectrum.

6. The biosecure method according to claim 1, wherein said light beam is substantially a single-wavelength one.

7. The biosecure method according to claim 1, wherein said part of the person's body is a finger of that person.

8. The biosecure method according to claim 1, further comprising the step of:
attaching an envelope to the part of the person's body.

9. The biosecure method according to claim 1, further comprising the step of:
directing the light beam to another one part or a plurality of parts of the person's body to generate additional light spectrum for subsequent analysis and comparison.

10. The biosecure method according to claim 9, wherein said step of directing the light beam are performed for a plurality of times and arranged in a particularly designed sequence.

11. The biosecure method according to claim 1, further comprising the step of:
updating the stored data by the analysis result, if the person is correctly identified.

12. A biosecure device for identifying a person, comprising:
a light source for directing a light beam to a part of the person's body;
a detector for measuring the light from the part of the person's body and converting the light intensity into electrical signals of a spectrum; and
a spectrum analyzer and comparator for analyzing the spectrum and comparing the spectrum with stored spectrum for the person.

13. The biosecure device according to claim 12, said light beam is substantially a single-wavelength one.

14. The biosecure device according to claim 12, wherein said light source comprises an LED.

15. The biosecure device according to claim 12, wherein said part of the person's body is further attached with an envelope.

16. A personal electronic apparatus comprising the biosecure device according to claim 12.

17. The personal electronic apparatus according to claim 16, wherein the personal electronic apparatus is a telephone.

18. The personal electronic apparatus according to claim 16, wherein the personal electronic apparatus is a computer.

19. The biosecure device according to claim 12, wherein the biosecure device is designed in the way of lock-and-key.

20. The biosecure device according to claim 12, wherein said spectrum comprises changes with respect to time.

21. The biosecure device according to claim 20, wherein said changes are analyzed by way of frequency analysis.

22. The biosecure device according to claim 21, wherein said frequency analysis comprises harmonic analysis.
